(19) United States
(12) Patent Application Publication
(10) Pub. No.: US 2021/0306797 A1
(43) Pub. Date: Sep. 30, 2021

(54) SYSTEMS, METHODS AND DEVICES FOR DETERMINING SOCIAL DISTANCING COMPLIANCE AND EXPOSURE RISKS AND FOR GENERATING CONTAGION ALERTS

(71) Applicants: Sam Johnson, Largo, FL (US); Devin Johnson, Largo, FL (US)

(72) Inventors: Sam Johnson, Largo, FL (US); Devin Johnson, Largo, FL (US)

(21) Appl. No.: 17/208,551

(22) Filed: Mar. 22, 2021

Related U.S. Application Data
(60) Provisional application No. 62/994,241, filed on Mar. 24, 2020.
(60) Provisional application No. 62/704,632, filed on May 19, 2020.

(51) Int. Cl. H04W 4/02; H04W 4/029; H04W 4/12; H04W 4/90

(52) U.S. Cl. CPC H04W 4/023; H04W 4/90; H04W 4/12; H04W 4/029

(57) ABSTRACT

A personal safety system is configured to receive and store information regarding a plurality of users, such as location information and health status information. The system determines compliance with social distancing guidelines, such as by comparing the locations of users to determine the distance between them. Upon receiving notice of contagion from a user, proximate users to the user may be notified. The system provide assessments, such as scores, of social distancing compliance and/or risk or exposure. A wearable device is configured to provide personal distance and inoculation indicators.

### RELATED APPLICATION DATA

This application claims priority to U.S. Provisional Application Ser. No. 62/994,241, filed Mar. 24, 2020, and U.S. Provisional Application Ser. No. 62/704,632, filed May 19, 2020, and incorporates each application by reference herein in its entirety.

### FIELD OF THE INVENTION

The present invention relates to devices, systems and methods for assessing and reporting social distancing compliance and generating contagion alerts.

### BACKGROUND OF THE INVENTION

Guidelines for limiting exposure to viruses such as COVID-19 indicate that persons should stay at least six (6) feet apart. However, it remains hard for individuals to assess whether they are complying with the guidelines, let alone for governmental entities or agencies to determine general public compliance with the guidelines.

Another problem with virus outbreaks like COVID-19 is identifying persons that may have come into contact with an infected person. Currently, this generally comprises interviewing the infected person to identify people they have interacted with or locations that they have visited, such as their office or various stores. This method, however, does not specify those individuals who were in close contact with the infected person. For example, an infected person might indicate that they were at a grocery store from 1-2 pm. This does not identify other persons who were at the same store or limit the potential persons exposed to those who were close to the patient and might, for example, have been at a completely different side of the store from the infected person.

An improved method and system for addressing these and other problems is desired.

### SUMMARY OF THE INVENTION

Embodiments of the invention comprise a method and system for one or more of: 1) generating or receiving and then storing information regarding a plurality of users, such as location information and health status information; 2) determining compliance with social distancing guidelines, including comparing the locations of users to determine the distance between them and whether such distances meet social distancing guidelines; 3) generating one or more scores, such as a social distancing score, such as based upon the user's conformity to social distancing guidelines, and/or health scores, such as a risk or exposure score; 4) reporting user compliance with social distancing guidelines and/or risk or exposure scores, such as to the user or third parties including governmental agencies; 5) receiving user contagion notifications; and 6) generating contagion alerts, such as by determining users who were in a designated distance of an infected user during a period of time, and sending such users contagion alerts.

In one embodiment, the system is implemented by a tracking platform, such as comprising one or more servers and databases.

In one embodiment, casinos, stores or other entities may implement features of the invention in association with an application, such as a customer loyalty application for the casino or store, wherein the tracking application may be associated with that customer loyalty application and where location information regarding the customer is provided to the tracking server in association with an anonymous ID.

Another embodiment of the invention comprises a wearable personal safety device. The device may be configured to provide an alert if a wearer thereof is within a designated distance of another person. The distance alert device may include a distance determining device, such as a time of flight sensor, for determining distances to other objects or persons. To distinguish between objects and persons, the device may include a human detector, such as an image detection device or heat sensor. In the event the device detects that the wearer is within a designated distance of another person, such as within a minimum safe social distance requirement, the device may trigger an alert such as a light. The wearable device may also be configured to provide an indication of inoculation status of the wearer.

In one embodiment, distance detection information and/or alerts generated by the wearable device may be provided to the tracking system of the invention, such as for use in determining compliance with social distancing guidelines. The alert device may have other functionality, such as providing information regarding an inoculation status of the wearer.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a tracking system of the invention;

FIG. 2 is a flow diagram of a tracking and alert method of the invention;

FIG. 3 illustrates one embodiment of a graphical user interface of the invention;

FIG. 4 illustrates another embodiment of a tracking system of the invention;

FIG. 5 illustrates a distance alert device in accordance with an embodiment of the invention;

FIG. 6 schematically illustrates a configuration of the device illustrated in FIG. 5; and

FIG. 7 illustrates aspects of use of the device illustrated in FIG. 5.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Aspects of the invention comprise systems, methods and devices for assessing and reporting social distancing compliance, generating risk or exposure assessments, and generating contagion alerts.

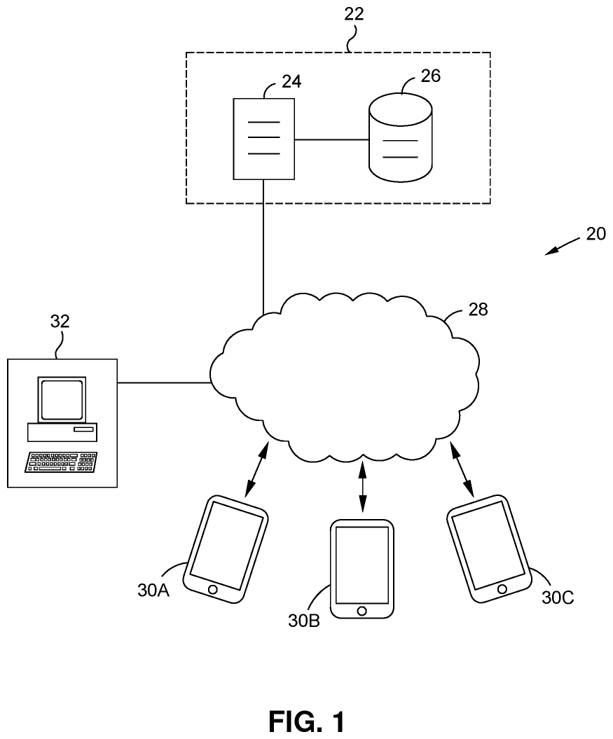

FIG. 1 illustrates one embodiment of a system 20 of the invention. As can be seen, the system 20 may comprise a centralized tracking platform 22. The tracking platform 22 may comprise one or more devices, such as a collection of linked devices. As one example, the tracking platform may comprise a server 24 capable of receiving user location information and contagion notices, generating scores and generating contagion alerts.

The server 24 may store information, such as user tracking information and the like, such as in at least one database 26. The database 26 may be associated with a data storage device (such as RAM, ROM, EPROM, hard drive, flash drive, optical media and associated reader, etc.). In addition, the database 26 or other storage need not be part of the server 24 but may be data storage that is remotely accessible to the server.

The server 24 preferably comprises a computing-type device. For example, the server 24 may comprise one or more processors, at least one communication device or interface, and may include one or more additional memory or data storage devices (such as separate from the database(s) 26). In one or more embodiments, the processor(s) is configured to execute one or more instructions, such as in the form of machine readable code (i.e. “software”), to allow the server 24 to perform the functions herein. The software is preferably non-transitory, such as by being fixed in a tangible medium. For example, the software may be stored in the one or more memory devices (RAM, ROM, EPROM, hard drive, etc.). One or more of the memory devices may be read-only. In addition, the software may be stored on a removable medium in some embodiments. In general, the one or more memory devices are used as temporary storage or may be used for permanent or near permanent storage (e.g. storage for long periods of time). For example, the one or more memory devices may be random access memory or cache memory used to temporarily store some information and/or instructions for execution by the at least one processor.

The software may comprise one or more modules or blocks of machine readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the server 24 may include one or more input and/or output devices. As one example, an operator of the tracking platform 22 might interface with the server 24 via a workstation or other device. Such a workstation or the like might comprise a keyboard, mouse, touchscreen, video display or the like, whereby the processor of the server 24 may receive information from an operator and/or output information thereto. This allows, for example, an operator of the server 24 to interface with the server 24 to upgrade, maintain, monitor, etc., the server or other aspects of the platform.

The communication devices or interfaces permit the server 24 to communicate with external devices, networks, systems and the like. As one example, as illustrated in FIG. 1, the server 24 may communicate with one or more user devices 30A,B,C (FIG. 1 illustrates an example where the server 22 communicates with three users, but the server 22 could communicate with two or more users, and preferably communicates with a large number of users). The user devices 30A,B,C, which may also communicate with each other, preferably comprise of mobile computing or communication devices. For example, the user devices 30A,B,C may comprise a tablet such as an iPad®, a telephone, a PDA, an Apple® watch or the like. Preferably, the user devices 30A,B,C are capable of receiving user input, transmitting data and receiving data (such as via a communication interface), and displaying information or data, such as via a video display. Preferably, the user devices 30A,B,C are configured to generate or obtain location information (regarding the location of the device itself) and to transmit that information to server 24. As described herein, the devices 30A,B,C may communicate with one another, with the server 24, or with other devices, such as a distance alert device as described below.

As illustrated in FIG. 1, the user devices 30A,B,C may have various locations. For example, a user device 30A,B,C might be carried by a user and thus move from location to location. A user device A,B,C might also be located in a fix location, such as an office building, home, apartment or the like. Of course, the user device 30A,B,C might be owned by the customer or might belong to a third party.

The communication interface of the server 24 may permit data to be exchanged between the server 24 and the user devices 30A,B,C (e.g. sent from the server to the user devices or sent from the user devices to the server) via one or more communication paths or links 28 (which paths may include one or more networks, including WANs, LANS, public or private networks, the Internet, cellular telephone networks or the like). The server 24 and user devices 30A,B,C may be capable of utilizing various communication protocols, such as 3G, 4G, 5G, TCP/IP, to communicate with a wide variety of other devices, and may communicate over wired and/or wireless links.

Location and other information may be uploaded to the server 24 and may also be stored in the database 26, and the server 24 may send information to the user. As indicated above, the communications may take place through one or more networks 28 (such as the Internet, etc.), such as shown in FIG. 1.

In one embodiment, the processor and other elements of the server 24 may be linked and thus communicate over one or more communication buses. In this manner, for example, the processor may read/receive software from the memory for execution, receive inputs and provide outputs to the various I/O devices, receive information from or output information to the communication interface, etc.

In one embodiment, each user device 30A,B,C also includes at least one processor and at least one memory device which stores software for execution by the at least one processor for implementing aspects of the invention, one or more communication interfaces and one or more I/O devices (such as video display, keypad or touchscreen, etc., as is known in the art relative to desktop and laptop computers, tablets, PDAs, etc.). In the case where the user's device 30A,B,C is a mobile communications device, the software may be in the form of an “application” or software application which the user downloads and installs on their device (such as by storing in it the memory). In a preferred embodiment, execution of the software at the server 24 and at the user device 30A,B,C causes the processors thereof to implement communications comprising the exchange of information or data between the devices, such as in the manner described below.

In other embodiments, the user's device 30A,B,C may implement a web browser and the tracking platform 22 may include or support a website, such as implemented by a webserver which is implemented by the server 24 or a separate server. The website may cause the web browser of the user's device 30A,B,C to present particular information, receive information and the like.

In one embodiment, the system 20 may be configured implement various functionality, including but not limited to one or more of: 1) generating or receiving and then storing information regarding a plurality of users, such as location information and health information; 2) determining compliance with social distancing guidelines, including comparing the locations of users to determine the distance between them and whether such distances meet social distancing guidelines; 3) generating one or more scores, such as a social distancing score, such as based upon the user's conformity to social distancing guidelines, and/or health scores, such as a risk or exposure score; 4) reporting user compliance with social distancing guidelines and/or risk or exposure scores, such as to the user or third parties including governmental agencies; 5) receiving user contagion notifications; 6) obtaining information regarding contagion inoculation; 7) generating inoculation notifications; 8) generating contagion alerts, such as by determining users who were in a designated distance of an infected user during a period of time, and sending such users contagion alerts; and/or 9) obtaining information from other sensors. As indicated above, various of the functionality may be implemented via software which is executed by a processor of the server 24 or processors of the user devices 30A,B,C.

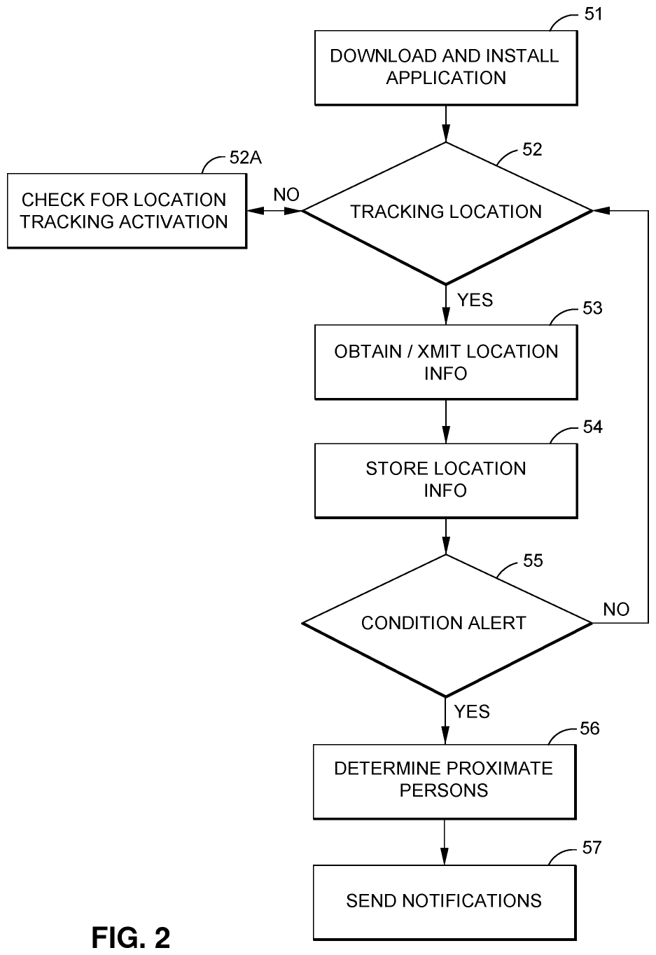

One embodiment of the invention will be described with reference to FIG. 2. In a step S1, a customer may download and install an application onto their user device 30A,B,C. As part of this process, the user might establish an account, such as with a user name and login information, and also set user preferences. As noted above, in other configurations, a user might simply use a web browser of their device to access a webpage or the like in order to implement features of the invention.

In a step S2, it may be determined if location tracking is active. In particular, in some embodiments, the user's location may not be tracked at all times. For example, location tracking might be enabled or disabled based upon various factors, including user preference. For example, a user might designate the location of their home. The tracking platform 22 might be configured to automatically turn off location tracking when the user is determined to be in their home, so that the location of the user is not tracked throughout their home. In other embodiments, the user might designate other locations where tracking is not to be enabled, or might turn tracking on and off manually. Thus, in step S2A, the system 20 may check to determine whether location tracking is active.

If location tracking is active in step S2, then information regarding the location of the user, and more specifically the location of the user as tied to their user device, is generated. Information regarding the user may be generated in various manners. In one embodiment, the user's device 30A,B,C may obtain GPS information. In another embodiment, the user's device 30A,B,C, may generate location information based upon cellular triangulation. Of course, a variety of now known and later developed techniques may be used to determine the user's location via their device. In some embodiments, a user might wear a device which generates or obtains location information (such as a GPS-enabled watch) and that device might report the location information to the user's device 30A,B,C (or potentially even provide the information directly to the tracking platform 22).

In a step S3, generated or obtained location information is transmitted to the tracking platform 22. In one embodiment, the information may be transmitted over a communication link to the platform 22.

In a step S4, the location information is stored, such as in the database 26 of the tracking platform 22. The location information is preferably time-stamped or otherwise time-encoded, and is stored in association with the user, such as the user's account.

In a step S5, a condition alert may be determined. A condition alert may be an input by a user that they have become ill, such as via a diagnosis of a doctor via a test. The condition alert might be input by the user to their user device 30A,B,C. If no condition alert exists, then the process may repeat at step S2, where it is determined if location tracking is to occur and, if so, to generate, obtain and store such information.

If in step S5 a condition alert is received or exists, then in a step S6, the tracking platform 22 generates information regarding persons that have been proximate to the user. The tracking platform 22 preferably analyzes the location of the user as against the location of other users (based upon location information of the other users that has been obtained and stored). The location information may be analyzed to determine other users that have been within a designated distance of the user (such as 6 feet, 20 feet, etc.), and/or for a designated period of time (such as 5, 10, 15 minutes or more), during a designated time (such as 1 day, 1 week, 2 weeks). This information is used to generate an identification of “proximate users.” In one embodiment, as described in more detail below, “proximity” may be determined by a plurality of factors and one or more scores may be generated, wherein events that have a score higher than a predetermined amount may be designated as “proximate user” event.

In a step S6, the tracking platform 22 generates one or more alerts and sends them to the proximate users. The alerts may comprise emails, SMS or text messages, push notifications, or other types of messages and are preferably sent to the user's device (but may be sent to other devices of the user, such as to an email account that might be accessed via a laptop or desktop computer, etc.). In one embodiment, message information is transmitted to the application on the user's device and the application causes the user's device to display the message.

The content of the message may vary. In one embodiment, the message may comprise a notification that the user was proximate to another user that recently became ill. The message might provide information regarding the location and time when the user was proximate to the user that became ill.

In one embodiment of the invention, the tracking platform 22 might also obtain information regarding a user's health. Such information might comprise, for example, a user's inoculation status, such as their up-to-date inoculation status against one or more diseases (viruses, etc.) In one embodiment, a user might be permitted to provide or update information regarding their inoculation status, such as information regarding the particular date/time/inoculation, etc. In other embodiments, the information may be provided by a third party, such as by medical personnel, such as to ensure the accuracy or authenticity of the information. As one example, a user might obtain an inoculation from their doctor or pharmacist. The doctor or pharmacist may then interface with the tracking platform 22 in order to provide information regarding the user's inoculation. This might comprise, for example, the doctor transmitting information from their office computer 32 to the tracking platform 22. The information might comprise information which identifies the user/patient and information regarding the inoculation (type, date, etc.) In other embodiments, the tracking platform 22 could be configured to “poll” one more databases for such information (such as governmental health entity, medical group, hospital, insurance company or other databases containing such information). In yet another embodiment, medical personnel might issue the user with an inoculation certificate. The certificate might comprise a paper or electronic form which includes information regarding one or more inoculations. For example, the certificate might be emailed or sent by text message from a doctor to their patient after receiving an inoculation. The user's might forward the certificate to the tracking platform 22 or the application associated with the user's device 30A,B,C might be configured to process the certificate. The certificate might include coded information or information which can be used to verify the authenticity of the certificate. The tracking platform 22 may store inoculation information, such as in association with a user or user's profile. In one embodiment, when an inoculation expires, the tracking platform 22 may be configured to flag or remove the inoculation information or otherwise indicate that the inoculation is invalid.

In one embodiment, as part of determining whether to generate a contagion alert, the tracking platform 22 may determine whether relevant persons have been inoculated. As one example, user X might have been in close contact with user Y, as determined by their locations. User X might be reported as being contagious as to a particular disease. The tracking platform 22 may determine that user Y was in close proximity to user X within a relevant time frame. However, the tracking platform 22 might also determine that user Y has been inoculated for the particular disease. As a result, the tracking platform 22 might not send a contagion alert to user Y, or might send an alert to user Y with information noting that they have been inoculated.

As another aspect of the invention, the tracking platform 22 may provide information to a user regarding how well they are complying with social distancing guidelines or requirements. In particular, upon the request of the user or at various times, information regarding social distancing compliance may be generated and provided to the user and/or other entities. The information might comprise, for example, a score. The score might comprise a social distancing score, which might, for example, focus on the user's compliance with social distancing requirements (including distance to third parties and/or contact time with third parties). The score might comprise a numerical value on a scale of 1-10 or 1-100 or the like, or might comprise a percentage value, such as a percentage value that reflects the percentage of time that the user is maintaining a desired distance from other users. However, other scores might be generated, and the scores might be based upon one or more additional or other factors. Such factors may comprise but are not limited to: time of contact time with others (such as the amount of time the user spends within certain distances of others, such as less than 3 feet, less than 6 feet, etc.), whether the user is vaccinated, whether the user washes their hands, touches their face or the like (as might be determined or detected by a personal safety device as describe below or by other means), presence of the user at events or locations with large numbers of persons (such as even if a safe distance is maintained), etc. For example, as described below, other assessments or scores that may be generated may comprise a risk/exposure score or a “personal health” score. Such a risk/exposure assessment or score may incorporate or include aspects of social distancing compliance and may further include assessment of additional information or factors, such as exposure to contagious persons, inoculation status, health status and other information as detailed herein.

In particular, the tracking platform 22 may analyze location data of the user and compare it to the location data of other users to determine how close the users are to one another (and as detailed herein, other information may be evaluated, such as how long the user and a third person are within certain distances of one another, whether the user was at a location with large numbers of third persons within a designated distance or within an identified space—as one example, using location information, the tracking platform 22 might identify that the user was at a stadium, bar or other location for large numbers of people and that may pose a higher risk of contagion). The tracking platform 22 may compare those distances to a desired distance, such as a desired or required social distance. This distance might comprise, for example, six (6) feet. The tracking platform 22 may then analyze the amount of time a user is at least 6 feet away from other users vs. the amount of time the user is greater than 6 feet away from other users, perform such an analysis based upon the number of other users the user encounters, etc.

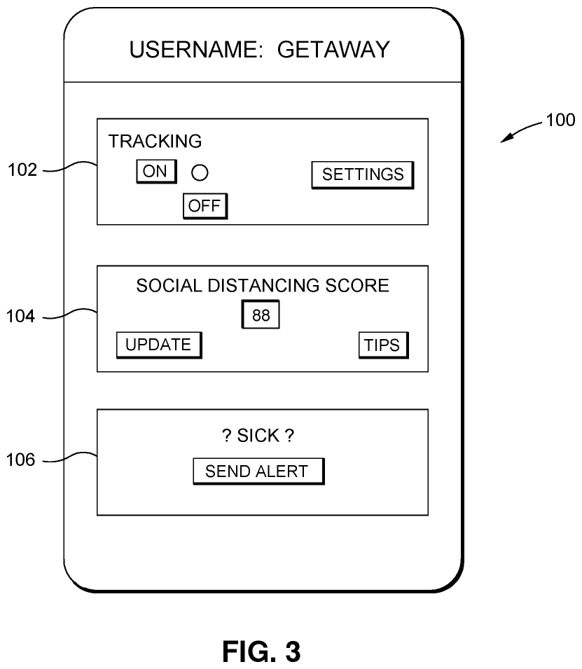

In one embodiment, an application running on the user's device 30A,B,C may be configured to generate one or more graphical user interfaces for displaying information to a user and/or receiving information or input from a user. FIG. 3 illustrates one embodiment of a graphical user interface 100. As illustrated, the graphical user interface 100 might display information regarding the status of location tracking 102, such as buttons for turning location tracking ON and OFF and a button for displaying tracking settings. The graphical user interface 100 might also display social distancing compliance information 104, such as a social distancing score (or, as described herein, other scores or assessments, such as a risk or exposure score). The graphical user interface 100 might also comprise buttons for a user to select to cause their score to be updated and/or to receive tips or helpful information (such as tips on how to maintain social distance in different situations and/or other health information). The graphical user interface 100 might be configured to display a distance between the user and a target individual. The displayed distance could include a numerical distance value (e.g., “7 FEET”), or might include other types of indicators, such as color (e.g., red, orange, green to indicate the “closeness” of the user to another person). In one embodiment, the graphical user interface might take over the entire UI/display and the user might face or direct the UI with the target individual so that the target individual can see the measured distance and indicate to them their participation in proper distancing.

The graphical user interface 100 might also display one or more buttons for receiving input from a user as to their health, such as to receive a “SICK” condition input from the user. Providing input to this button may cause an alert to be sent to the tracking platform 22 that then triggers the process noted in steps S6 and S7 illustrated in FIG. 2 and described above.

Of course, the graphical user interface 100 might have other configurations and/or be configured to display other information. For example, the graphical user interface 100 might display a selectable menu, might display user login information or the like.

FIG. 2 illustrates just one flow diagram of aspects of a method of the invention. It will be appreciated that the invention may be implemented by other methods, including methods with additional steps or lesser numbers of steps. Also, the steps illustrated in FIG. 2 and described above might be performed in various orders and not necessarily in the specific order shown and described. In addition, the system and method of the invention may include additional features.

As one example, instead of the user devices 30A,B,C directly providing location information to the platform 22, the platform 22 might obtain the information from a remote source. For example, user location information might be collected by a third party server (such as via Google, Apple or other third parties). The platform 22 might obtain the location information from those third parties and utilize the location information as described above.

As indicated above, the devices 30A,B,C may communicate with the server 24. However, the devices 30A,B,C may also communicate with one another. For example, user devices 30A,B,C may track or store (such as provided from a linked device such as wearable health monitor, temperature sensor or the like), information such as the user's temperature, the user's social distance compliance score, risk/exposure score, etc. In one embodiment, such information may be shared between devices 30A,B,C (directly or indirectly, such as via Bluetooth, such as where the application on the device 30A,B,C is configured to auto-detect other user devices that are running the application and are within a designated distance of the user).

In one embodiment, user information (including assessments or scores) might be provided to third parties, such as governmental agencies. The information could be made user-anonymous. For example, the platform 22 might be configured to report to a governmental agency the social distancing compliance information for a number of users, thus enabling the agency to determine how well users in their jurisdiction are maintaining desired social distances. As one example, the platform 22 might report the individual or combined social distancing scores of all users in Arizona to the Arizona Department of Health Service. This information might be used to determine how well people in Arizona are complying with social distancing guidelines.

Similarly, contagion alert information might be shared with third parties. For example, the number of users that indicate they are sick may be reported to one or more third parties, such as governmental agencies. Such agencies might use the information for various purposes, including but not limited to: 1) determining the number of sick/infected people; 2) determining a rate of infection; 3) determine areas of contagion; 4) predict future rates and locations of contagion; and 5) take pro-active or remedial measures, such as by providing health notifications, marshalling health care resources where the resources are necessary, etc.

One consumer complaint with companies like Google and Apple is that those companies gather and use customer information in unauthorized manners or in manners not known to them, including by selling the information. In some cases, exploitation of the information has also resulted in breaches or disclosures of personal information.

As one aspect of the invention, the platform and the associated mobile device application may be entirely single purpose, and may be configured to store and use data anonymously. This protects other information of the user from being co-mingled with the tracking and notification information of the platform. In one embodiment, user location information may be stored in association with a user ID, which user ID does not include a name or other identifying information of the user. For example, User A might be assigned ID #22 and User B might be assigned user ID #46. If User A becomes ill and provides a contagion alert and User B was determined to be in proximity to User A, the platform could provide a contagion alert to User B without needing to know or store identity information regarding User B, simply by sending an alert to the application of User B. Likewise, contagion information regarding User A could be provided to governmental agencies without identifying User A (such as by providing a notification that “a user” in a particular location provided a contagion alert at a particular time.

As indicated above, a user's proximity score or risk/exposure score might be provided to one or more third parties for various purposes. For example, the user's risk or exposure score might be provided to an employer as part of assessing the risk that the user might infect other employees. The user's risk or exposure score might be used to determine whether they should be permitted to travel (such as via a traveler database). The user's risk or exposure score might be provided to an insurance company, such as for determining health risks and associated premium costs, or might be associated with a user's credit profile or the like (in such instances, the user's identity would not be anonymous and the user might be required to permit such reporting, such as to comply with HIPA regulations).

The platform and application may enable additional functionality. As one example, the application may allow a user to obtain detailed information regarding an alert, such as additional information about their potential exposure, such as location of exposure, the time/date of the exposure, the duration of the exposure, etc., such as in text form or in a graphical interface that might include a map which shows the location and/or associated information.

In one embodiment, a user might be permitted to view information regarding their past movement, including information regarding their interaction with third parties. For example, upon receiving an alert, the user might request that the platform 22 and/or application generate and display (from tracked/stored location information), information regarding their movements/locations after exposure. As another example, a user might be permitted to view information regarding their past interactions with third persons. For example, the user might request the platform 22 and/or application to generate and display information which shows their past movement, including their interaction with third persons. For example, upon receipt of an input from a user to the application of a request for such information, the platform 22 might utilize the stored information to cause the application to display (such as at the user's device 30A) a map which shows the user's location at a particular time or over a period of time, along with information regarding their interaction with third persons. The third persons might be displayed as dots or avatars and might include associated secondary information. For example, known infected persons might be shown in red, with others shown in green. As another example, persons that came within a particular distance of the user and/or were proximate to the user for one or more designated periods of time, might be distinguished (such as red for third persons that were less than 6 feet from the user for more than 10 minutes, yellow for third persons that were less than 6 feet from the user for less than 10 minutes, and green for third persons that were more than 6 feet from the user), or the like. In certain embodiments, a user may be permitted to filter the displayed information, such as based upon certain criteria such as distance to user, time duration of interaction with user, etc. In some embodiments, a user may be permitted to select a displayed third person to gain more information, such as information about whether the third person is vaccinated, etc.

In one embodiment, the map or other interface may be animated, such as where the locations of the user and third persons change on the map corresponding to their actual movement. The user might be permitted to pause the animation, reverse it, or speed it up. As one example, a user might attend a function. The next day, the user might desire to play the map of their location in relation to third parties at the function. The animated map would show the user's movement in relation to third parties at the function, including interaction with third persons, passing by third persons etc. If one or more of the third parties were contagious, the user could then see how close they were to those third persons, how much time they spent interacting with those persons, etc.

In one embodiment, the user might select a third person and the platform 22 might generate detail information about the relationship of the user to the third person. For example, by selecting a third person, the platform 22 might indicate the closest distance of the third person to the user during a certain time interval and/or how long the third person and user were in contact with one another. In another embodiment, the platform 22 might generate a proximity score for each third person. That proximity score (which as noted above, might be calculated based upon one of more factors such as distance from user, time of contact with user and/or the combination thereof) and that score might be shown relative to each third person on the map, or might be shown when the user selects a third person. In another embodiment, instead of a proximity score, a risk or exposure score (or “personal health” score) might be generated. This score might be calculated based upon similar factors as the proximity score, and/or with one or more additional factors such as, but not limited to: whether the third person is contagious, whether the user and/or third person are vaccinated, the age or health status of the user, etc. It is noted that the user's proximity and/or risk/exposure score may change over time, including continuously, based upon the movement or other actions of the user, including their interaction with third parties.

In one embodiment, aspects of the invention may be implemented as part of an existing application, or as linked or tied to an entirely different application, such as for use in particular environments. For example, casinos or stores may desire to provide notifications to their customers in the event of a contagion event that involves one of their customers. Often, such casinos or stores have existing loyalty applications which their customers install on their mobile devices. These applications may provide various functionality, such as by providing promotional offers, providing information regarding tracked purchases or other activities.

In accordance with the present invention, an application of the present invention may be associated with such a customer loyalty application (such as by communicating therewith or linking thereto) or might be implemented as an “add-on” thereto. As one example, a tracking application of the invention may be associated with a casino player loyalty application. The first time the player runs the player loyalty application, they may be prompted to enable GPS tracking and/or to turn on Bluetooth functionality for additional tracking, as well as allow for notification to be sent (if the application detects that this functionality is not already activated). The tracking portion of the application may also generate a UUID or GUID (e.g., an identifier which is unique to each player or customer, but which is anonymous and does not include identifying information regarding the player or customer). The tracking portion of the application then simply runs in the background of the player loyalty application. Further, the tracking portion of the application can be configured to automatically turn on when entering the physical premises operated by the loyalty application (e.g., casino, car (in the case of a ride-share loyalty app), public transportation, etc.) and automatically turn off upon exiting the premises. This can help to instill confidence in the customer wanting to enable the tracking portion of the loyalty app, whereby such feature is knowingly being used only when on the premises of the provider of the loyalty app.

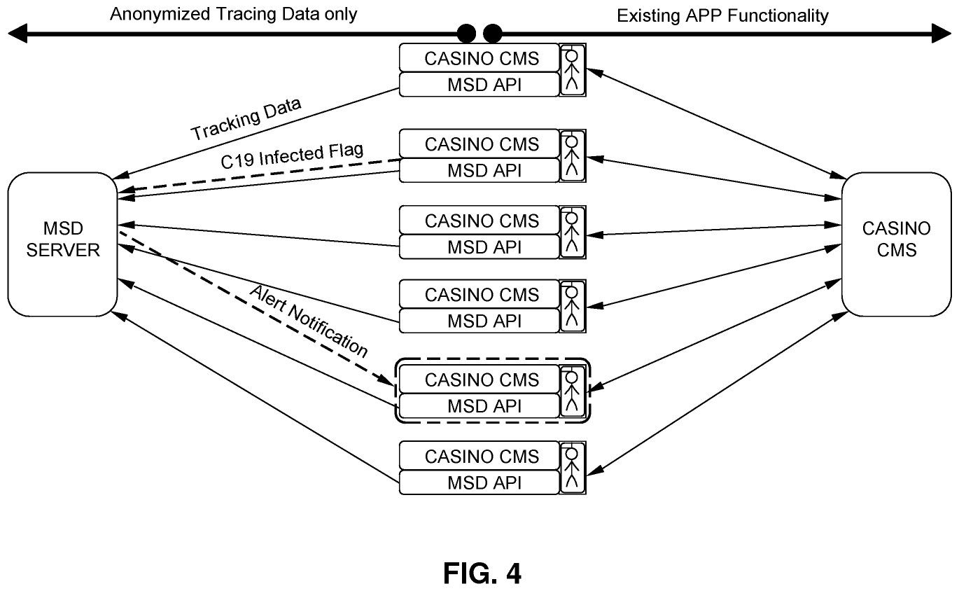

As the player loyalty application and associated tracking application runs, it gathers location information. As illustrated in FIG. 4, the location information may be transmitted to the tracking server 24 of the tracking platform 22 (see FIG. 1) as linked to the UUID or GUID which has been assigned to the player. In the event of a contagion event, the player may provide input to the application, such as in the manner described above, thus causing the server 24 to evaluate the stored location information in the manner described above and send out one or more contagion alerts. In this manner, a casino or other store can provide contagion alerts for their customers, but in a manner by which the casino or store does not directly store information regarding the players or customers and their locations, etc.

In one embodiment, a user might have a plurality of such loyalty applications installed on their device. In such a configuration, the tracking application of the invention might be linked to each of those loyalty applications. Such a linking may be facilitated by an application program interface (API) or other means. In one embodiment, the application may be configured to detect other applications, including newly added applications, such as to display an option (such as via a selector) to the user to associate those applications with the tracking application, or which otherwise allows the user to manually link the applications. In this manner, each tracking enabled loyalty applications may optionally communicate with each other (such as by cross-sharing information/data). In one embodiment, an option may be provided whereby when the user enables tracking relative to one of their loyalty applications, tracking is enabled relative to all loyalty applications on the user's device. As one example, a player might have a loyalty application for Casino A and another loyalty application for Casino B installed on their device. Once the player implements tracking in association with the loyalty application for Casino A, tracking may automatically be implemented relative to the loyalty application for Casino B (thus not requiring the player to separately enable this feature for each loyalty application). Further, tracking information relative to those different loyalty applications may commonly be shared.

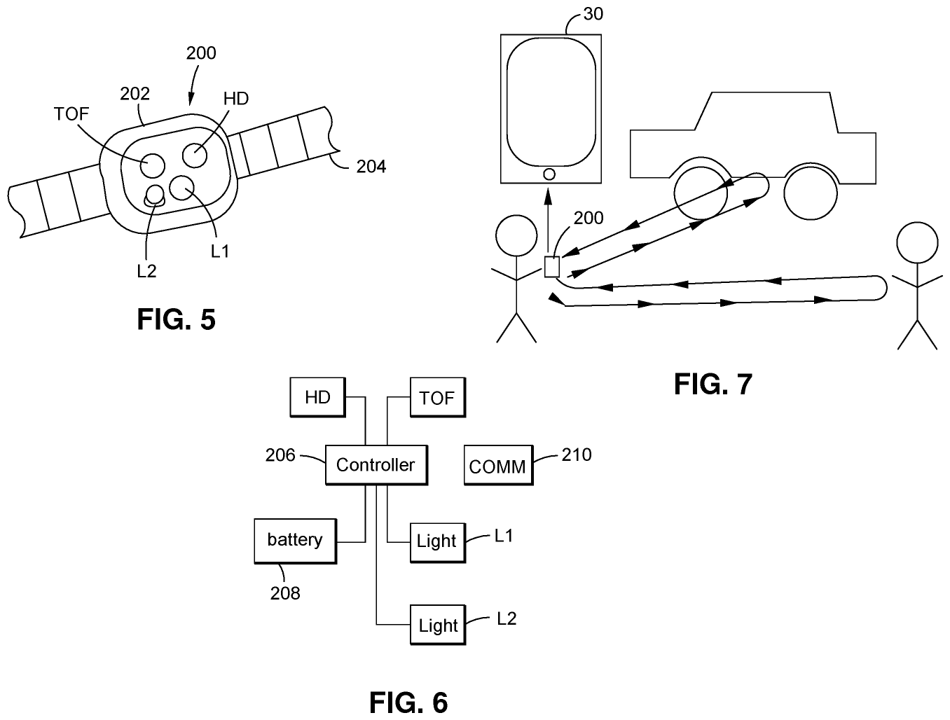

Another aspect of the invention will be described with reference to FIGS. 4-6. This aspect of the invention comprises a method and device for providing social distancing alerts or contagion related information. One embodiment of a distance alert device 200, which might be referred to as a “safe distance” alert device or by other terms, is illustrated in FIG. 5. In a preferred embodiment, the distance alert device 200 is wearable by a user. As described below, the distance alert device 200 might have a number of forms.

As illustrated in FIG. 5, the distance alert device 200 may comprise a housing 202 for housing or supporting the components of the device 200. The shape of the housing 202 may vary, such as depending upon how the device 200 is intended to be worn.

In one embodiment, the housing 202 has a front and a rear. The rear might be configured to face the wearer when the device 200 is worn, whereas the front might be configured to face away from the wearer. The device 200 may include a human detector HD, a time of flight or “distance determining” device TOF, and one or more wearer alert devices, such as a light L.

The human detector HD preferably comprises a sensor which is capable of generating information which is useful in distinguishing a person from objects. For example, the human detector HD might comprise a heat sensor (such as an infrared detector) which can thus detect a heat signature from a human as compared, for example, from an inanimate object. Such heat signature can also provide an accurate account of the internal temperature of the human (e.g., 98.6) degrees F.) which can also be stored in conjunction with stored distance/location events. Of course, the human detector HD might comprise other sensors or devices, such as an image capture device and an associate image recognition or analysis device (such as software running on a controller of the device 20), a device for sensing the size of a person or other object, etc.

The time of flight or “distance determining” device TOF may comprise any number of sensors or devices which are capable of determining a distance between the device 200 and another object. The TOF device might comprise, for example, a LIDAR device, a time of flight camera, a RADAR device or other types of devices now known or later developed.

In one embodiment, the device 200 is configured to be worn by a user. The device 200 may thus include means for coupling, mounting or connecting it to the wearer (either directly, such as worn on the body, or indirectly, such as by being connected to clothing). As illustrated, this means might comprise a strap 204, such as to permit the device 200 to be worn on the head, on the arm, around the waist or the like. The means might also or instead comprise a belt clip or a hook material for engagement with a fabric (such as Velcro™ brand hook and loop material).

In other embodiments, the device 200 might be integrated into another object, such as an article or clothing or other object worn by the wearer. For example, the device 200 might be integrated into or coupled to a hat or necklace which may be worn by the wearer.

FIG. 6 schematically illustrates a configuration of the device 200. As illustrated, the device 200 may comprise a controller 206, a power source such as a battery 208, a communication interface 210, and the human detector HD, the time of flight device TOF and the light L. In one embodiment, the controller 206 comprises a processor. The processor might be pre-programmed, including being configured as a hardware chip. In other embodiments, the controller may comprise a processor which is configured to execute machine-readable code (e.g. “software”), such as stored in an associated memory (not shown). The controller 206 may communicate with one or more external devices or systems via the communication interface 210. The communication interface 210 may comprise, for example, a wireless communication interface that supports Wi-Fi, Bluetooth, cellular or other communications (or might permit wired communications, such as by comprising a USB port, Ethernet port, etc.)

In general, the controller 206 is preferably configured to implement the functionality noted herein.

Operation/use of the device 200 will be described with reference to FIG. 7. As illustrated, when the device 200 is active, the time of flight device TOF may be used, such as in conjunction with the controller 206, to determine the location of objects within a designated distance of the wearer. This distance may be pre-set or might be user-selectable and might comprise, for example, a social distancing guideline distance, such as 6 feet (2 m).

In one embodiment, when the device 200 detects an object within the designated distance of the wearer, the controller 206 may trigger the wearer alert, such as by illuminating the light L1. For example, if either or both the car and the other person illustrated in FIG. 7 are within the designated distance, the controller 206 may trigger the alert. As another example, the light L1 might flash in a particular direction to alert another person as they approach the wearer to pass the wearer on a designated side of the wearer (for example, a person who is approaching the wearer from behind might be alerted with a left-blinking arrow or light or other indicator in order to alert the person to pass the wearer on the left side).

However, in a preferred embodiment of the invention, information from the human detector HD may be used to limit alerts to situations when the object that is within the designated distance of the wearer is determined to be (or believed to be) a human. For example, the controller 206 may receive a signal from the time of flight device TOF that an object is within 6 feet of the wearer. However, the controller 206 may also receive a signal from the human detector HD that the object not a human (such as by having a cold heat signature or via image recognition, etc.—either as determined by the human detector HD or based upon data provided to the controller via the human detector HD). In that case, the controller 206 may not trigger an alert. However, if the information from the human detector HD indicated that the object was a human, then the controller 206 would trigger the alert. In the event of an alert, the wearer is alerted that they are likely too close to another human, thus causing them to evaluate their surroundings and, if necessary, change their position or take other corrective action. For example, relative to FIG. 7, the device 200 might identify that the car is within the designated distance, but is not a human because it does not have the required heat signature), but the device 200 might identify the other person as a human and within the designated distance, thus triggering the alert and letting the user know that they are too close to another human.

It will be appreciated that a wearer might wear more than one device 200, such as for detecting the proximity of persons in front of or behind themselves, and may benefit a wearer who is standing, walking, riding a bike or engaged in various activities. To facilitate alerts by a device which is worn on the back of a wearer, the alerting device or mechanism might comprise a vibration device or a buzzer, rather than a light. In other embodiments, two or more of the devices 200 of a single wearer might be “paired”, whereby an alert condition of any one of them causes all of them to provide an alert. Thus, a device 200 worn on the back of a wearer might trigger an alert that causes a device 200 at the front of the wearer to illuminate. Further, alerts might comprise different colors of lights depending upon proximity or direction (brighter or a first color for very close persons or persons moving towards the wearer, and dimmer or a second color for persons who are farther away or moving away from the wearer) and might include other types of lights (including arrows, sequences of lights, etc.) or displays. Also, audible alerts might be provided, such as via a speaker or via a link to the user's mobile device, which audible warning might provide detailed alert information.

In one embodiment, information from the device 200 might be shared with one or more external devices or systems, such as the wearer's mobile communications device 30. The mobile communication device 30 might track and store alert events. These events might also be correlated to location data, such as described above. Of course, this information might also be transmitted directly to one or more remote systems, such as the remote server 24 of the system illustrated in FIG. 1, or via the mobile device 30. In this manner, social distancing tracking may further include information regarding alert events generated by the device 200.

Of course, the device 200 might have other configurations. For example, although preferred, the device 200 might not include the human detector HD.

In another embodiment, the device 200 might include an identifier. The identifier might comprise a device which is configured to detect, such as by transmitting and/or receiving a signal, another identifier. In this manner, when the device 200 is worn by a wearer and comes into range with a device 200 which is worn by another wearer, the two devices 200 directly identify themselves, allowing the controller 206 to signal an alert (either as a result of such an identification or such an identification coupled with a notice from the time of flight device TOF that the other wearer is within the designated distance).

Another aspect of the invention comprises a device which is configured to provide information to third parties regarding an inoculation status. Such a device might comprise a device 200 such as that described above which has additional or other functionality. In other embodiments, the device might be a special purpose device or have other additional functionality. As one example, the device 200 which is described above may include at least one indicator which is activated when the wearer is inoculated against one or more particular contagions. As one example, the device 200 might include a visual indicator such as a display or light L2 which is illuminated when the wearer is inoculated against a particular spreading contagion. The display or light L2 might be illuminated by the controller 206, such as upon receiving an instruction or information from a remote system (such as the tracking platform 22) or via the user's device 30. In one embodiment, the device 200 may be configured so that the visual indicator can only be activated and remain activated when the device 200 is paired to the user (so as to prevent another user from wearing the device when that user may not be inoculated), such as by the user's device 30 being in a certain range of the device 30 (such as within Bluetooth signal range, etc.). As one example, in this configuration, a user may get an inoculation for a disease. During an outbreak of the disease, the device 200 may illuminate a green light L2. The green light provides an indication to third parties that the user has been inoculated.

Another aspect of the invention comprises a device which is configured to obtain, capture or measure health data regarding the user. The device might again have functionality such as described above and include this additional functionality. In one embodiment, the device is preferably configured to be worn by a user and includes one or more sensors or detectors, such as for detecting or sensing the user. As one example, the device might be configured with a sensor, such as a stethoscope (which may comprise an audio sensor) which can detect a user's heartbeat, lung inhalation/exhalation or other audible information. The device might include other sensors, such as motion sensor or camera for detecting movement of a user's arms, such as for determining whether the user is washing their hands or touching their face, a thermometer/temperature sensor, etc.

In one embodiment, the device 200 or the user's mobile device 30 may be configured to directly use and analyze data, such as from the sensor(s) and/or may transmit that information to a remote platform, such as the tracking platform 22 described above. The tracking platform 22 may store and/or analyze the information, such as part of providing social distancing assessments, risk/exposure scores, etc.

In one embodiment, the one or more sensors might be mounted to the housing 202 of the device 200. When the device 200 is worn, the sensor may be configured to sense or detect information, such as by being placed into contact with the user. In other embodiments, the one or more sensors might be remote sensors, such as a worn separately from the device 200 but communicating therewith. For example, the sensor(s) might be associated with a strap, bracelet or other mount that allows the user to wear the sensor in locations other than the device 200, such as in the form of a chest strap, arm strap, wrist strap/bracelet, etc.

In one embodiment, the one or more sensors may be configured to communicate with the controller 206 of the device. As noted above, however, the sensors might be associated with a completely different device, such as by comprising a special purpose device. Such a device might comprise, for example, a chest strap that includes one or more sensors, a processor and a communication interface. The interface may allow information captured by the sensor(s), including as processed by the processor, to be transmitted to one or more remote devices, such as the user's device 30 and/or the tracking platform 22.

In one embodiment, the captured health information or data regarding a user may be used in conjunction with the above-described information, such as contagion exposure, such as to generate one or more alerts. As one example, if a user has identified themselves as being contagious, the information from the one or more sensors might be used to determine a condition of the user, including health issues that may require attention by the user. As another example, if the device 200, the user's device 30 (such as via the application running thereon) or tracking platform 22 detects that the user is becoming sick, such as based upon the analysis of heart or lung data obtained from the sensor(s), their temperature or the like, the user's device 30 and/or tracking platform 22 may generate a notification to the user that they may need to seek medical attention, may alert medical authorities, etc. as they might be at risk of having a contagion. As one example, if using such information it is determined that the wearer is likely sick, the wearer may be reported as potentially contagious, even before the wearer indicates such to the platform 22. This allows the platform 22 to notify third parties of their risk of contagion earlier.

In other embodiments, if a user has been reported as being in the proximity of a contagious person, the user's condition may be monitored for signs they are becoming sick. The user's device 30 or tracking platform 22 may analyze sensor data for indicators that the exposed user is becoming sick, thus potentially identifying and/or alerting the user that they have cause the disease before they are otherwise aware of such. In that instance, the tracking platform 22 may then use the user's tracking data to alert others who were in proximity to the user that they may have been exposed—essentially creating a chain of notifications based upon reported notices of contagion and/or sensed contagion status.

In another embodiments, the device 200 may include a UVC light emitter, such as UVC 222 nanometer spectrum light. The light may be projected outwardly, such as to kill any potentially harmful pathogens in the space around the user. For example, before the user is about to pick up an object, the user might ensure that they face the object and/or point the light towards the object (such as by turning their head towards the object when the device 200 is worn on their head) so as to irradiate the object with UVC light before touching it.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A personal safety tracking system comprising:
a tracking platform, said tracking platform comprising at least one server, a server communication interface, a processor, a memory and machine readable code stored in said memory and executable by said processor to cause said server to:
receive location information regarding a plurality of users at a plurality of times;
store said location information in said memory;
receive a contagion alert from one of a sick user;
determine one or more proximate users to said sick user, said proximate users comprising those users who are determined to have been within a certain distance of said sick user within a designated time period, based upon said stored location information; and
transmit a contagion alert to each of said proximate users.

2. The system in accordance with claim 1, wherein said server is further configured to receive inoculation information regarding one or more of said plurality of users and wherein said one or more proximate users comprise those users who are determined to have been within a certain distance of said sick user within a designated time period, based upon said stored location information, and who were not inoculated.

3. The system in accordance with claim 1, wherein said location information is received from mobile communication devices of said users and said contagion alert is transmitted to said mobile communication device of said proximate user.

4. The system in accordance with claim 1, wherein said location information is received from an application running on a mobile communication device of said user.

5. The system in accordance with claim 4, wherein said application comprises a casino loyalty application.

6. The system in accordance with claim 1, wherein said proximate users comprise users who are determined to be proximate to said sick user based upon a distance to said sick user and a duration of interaction with said sick user.

7. The system in accordance with claim 1, wherein said contagion alert comprises information regarding interaction between said proximate user and said sick user.

8. The system in accordance with claim 7, wherein said information comprises map information showing a location of interaction between said proximate user and said sick user.

9. A personal safety system comprising:
a tracking platform, said tracking platform comprising at least one server, a server communication interface, a processor, a memory and machine readable code stored in said memory and executable by said processor to cause said server to:
receive location information regarding a plurality of users at a plurality of times;
store said location information in said memory;
analyze said stored location information of a user against stored location information of other users to determine a distance between said user and said other users;
determine if said distance is greater or less than a social distance guideline;
generate a score based at least upon said user's compliance with said social distance guideline; and
transmit said score to said user.

10. The system in accordance with claim 9, wherein said score comprises a social distance score.

11. The system in accordance with claim 9, wherein said score is further based upon a duration of interaction between said user and said other users.

12. The system in accordance with claim 9, further comprising transmitting said score to a third party.

13. The system in accordance with claim 12, wherein said third party comprises at least one of an insurance company, a governmental agency, and a credit reporting entity.

14. The system in accordance with claim 9, further comprising transmitting information to said user regarding interaction between said user and one or more of said other users.

15. The system in accordance with claim 14, wherein said information is transmitted to a device of said user and causes said device to display map information showing one or more interactions between said user and said one or more other users.

16. A social safe distance alerting device configured to be worn by a wearer, comprising:
a wearable housing;
a controller located in said housing;
a distance determining device; and
an alert mechanism;
wherein said controller is configured, in conjunction with said distance determining device, to determine whether persons are detected with a designated distance of the wearer, and when so determined, so trigger said alert mechanism.

17. The device in accordance with claim 16, wherein said distance determining device comprises a time of flight sensor.

18. The device in accordance with claim 16, wherein said alert mechanism comprises at least one visual indicator.

19. The device in accordance with claim 16, further comprising at least one sensor configured to sense a condition of the wearer.

20. The device in accordance with claim 16, further comprising means for detecting the presence of said persons, wherein said controller is configured to determine whether persons are detected with a designated distance of the wearer based upon an output of the means for detecting and an output of said distance determining device.
